(19) United States
(12) Patent Application Publication
(10) Pub. No.: US 2014/0285218 A1
(43) Pub. Date: Sep. 25, 2014

(54) SOCKET CAPABLE OF DECTECING APPROACHING OBJECT

(71) Applicant: Nai-Chien CHANG, New Taipei City (TW)

(72) Inventor: Nai-Chien CHANG, New Taipei City (TW)

(21) Appl. No.: 14/209,218

(22) Filed: Mar. 13, 2014

(30) Foreign Application Priority Data
Mar. 19, 2013 (TW) 102205031

(51) Int. Cl. G01B 7/00

(52) U.S. Cl. CPC G01B 7/003
USPC 324/658

(57) ABSTRACT

A socket capable of detecting an approaching object, which is used to be electrically connected to a mains supply and comprises a relay (200), a socket base (300), a capacitance sensing circuit (400), and a detection electrode (500). The relay (200) is electrically connected to the mains supply. The socket base (300) is electrically connected to the relay (200) and provided with two insertion holes (320) having strip shapes and arranged in parallel. The capacitance sensing circuit (400) is electrically connected to the relay (200). The detection electrode (500) is electrically connected to the capacitance sensing circuit (400). Thus, the approaching object can be detected and the power supply from the mains supply for the insertion holes (320) can be stopped.

### BACKGROUND OF THE INVENTION

1. Field of the Invention

The present invention relates to a socket and, in particular, to a socket capable of detecting an approaching object.

2. Description of Related Art

A socket is a common item in daily life. The electric devices almost depend on the mains supply to operate and the socket serves a medium of electrical connection between the electric devices and the mains supply. The mains supply is a high-voltage AC electric power and people use (plug into) the socket in daily life quite frequently. Therefore, if the socket is poorly designed, it will result in a higher possibility of electric shock.

The electrode sheets are disposed in two insertion holes for a traditional socket, which is not easily touched by a user, thus, preventing the user from getting an electric shock. However, when the user is plugging the electrodes of the plug of the electric device into the socket, the electrodes of the plug are electrically conducted to those of the socket. During the period of the electrodes of the plug not fully being plugged into the socket, a careless user probably touches the electrodes of the plug and thus gets an electric shock.

In view of this, the inventor pays special attention to research with the application of related theory and tries to overcome the above disadvantages regarding the above related art, which becomes the goal of the inventor's improvement.

### SUMMARY OF THE INVENTION

The present invention is to provide a socket capable of detecting an approaching object based on capacitance variation.

The present invention provides a socket capable of detecting an approaching object. The socket is used to be electrically connected to a mains supply and comprises a relay, a socket base, a capacitance sensing circuit, and a detection electrode. The relay is electrically connected to the mains supply. The socket base is electrically connected to the relay and is provided with two insertion holes having strip shapes and arranged in parallel. The capacitance sensing circuit is electrically connected to the relay. The detection electrode is electrically connected to the capacitance sensing circuit.

Preferably, the above-mentioned socket capable of detecting an approaching object further comprises a cover plate having a through-hole in which the socket base is disposed. The two insertion holes are located in the through-hole.

Preferably, in the above-mentioned socket capable of detecting an approaching object, the detection electrode extends to surround the socket base.

Preferably, in the above-mentioned socket capable of detecting an approaching object, there are a plurality of socket bases.

Preferably, the above-mentioned socket capable of detecting an approaching object further comprises a cover plate having a plurality of through-holes. Each of the socket bases is disposed in the corresponding through-hole; the two insertion holes of the each of the socket bases are located in the corresponding through-hole.

Preferably, in the above-mentioned socket capable of detecting an approaching object, there are a plurality of detection electrodes. Each of the detection electrodes is individually electrically connected to the capacitance sensing circuit.

Preferably, in the above-mentioned socket capable of detecting an approaching object, each of the detection electrodes extends to surround the corresponding socket base.

The socket capable of detecting an approaching object of the present invention detects an approaching object by means of the capacitance sensing circuit and the detection electrode such that the relay is opened to stop the power supply for the socket to prevent the user from getting an electric shock. Therefore, the present invention effectively overcome the disadvantages of the prior art.

### BRIEF DESCRIPTION OF DRAWING

FIG. 1 is an exploded schematic view of the socket capable of detecting an approaching object according to the first embodiment of the present invention;

FIG. 2 is a schematic view of the socket capable of detecting an approaching object according to the first embodiment of the present invention;

FIG. 3 is a schematic view of the socket capable of detecting an approaching object according to the first embodiment of the present invention in operation;

FIG. 4 is an exploded schematic view of the socket capable of detecting an approaching object according to the second embodiment of the present invention; and

FIG. 5 is a schematic view of the socket capable of detecting an approaching object according to the second embodiment of the present invention.

### DETAILED DESCRIPTION OF THE INVENTION

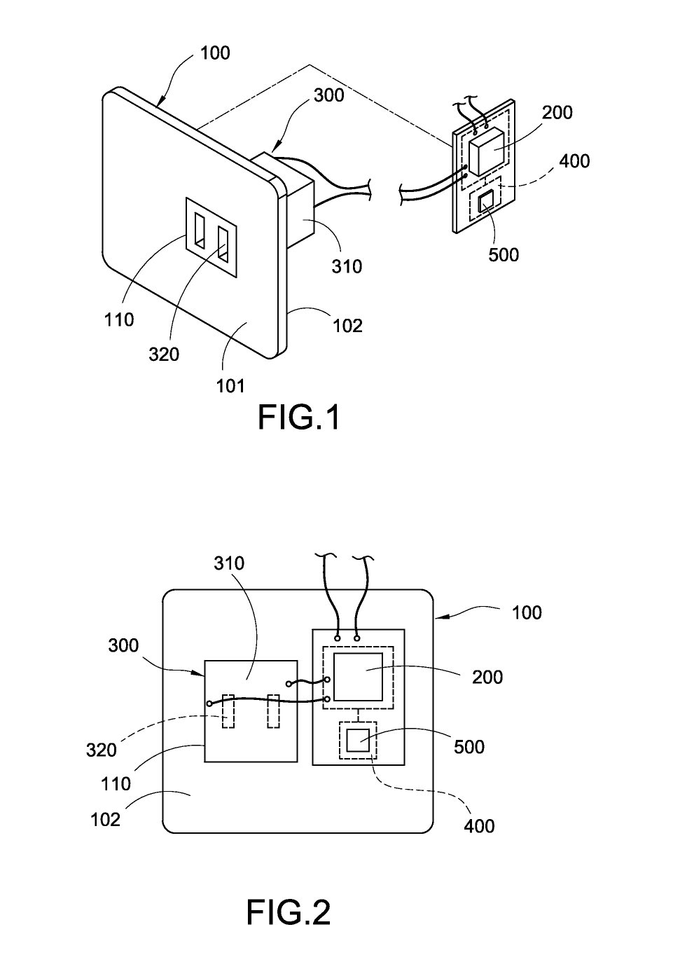

Please refer to FIGS. 1 and 2. The first embodiment of the present invention provides a socket capable of detecting an approaching object. The socket is used to be electrically connected to a mains supply. In the current embodiment, the socket capable of detecting an approaching object comprises a cover plate 100, a relay 200, a socket base 300, a capacitance sensing circuit 400, and a detection electrode 500.

The cover plate 100 is a cover body having a plate shape. Two opposite sides of the cover plate 100 are an outer surface 101 and an inner surface 102. The cover plate 100 has a through-hole 110. The relay 200, disposed on the inner surface 102, is electrically connected to the mains supply. The socket base 300 is electrically connected to the relay 200. The socket base 300 preferably comprises a rectangular insulator 310 which is disposed firmly in the through-hole 110 of the cover plate 100. The insulator 310 is provided with two insertion holes 320. Each of the two insertion holes 320 has a strip shape opening. The two openings of the two insertion holes 320 are arranged in parallel and are exposed from the through-hole 110 to the outer surface 101 of the cover plate 100. Each of the two insertion holes 320 is provided with an electrode and is electrically connected to the mains supply via the electrode. The capacitance sensing circuit 400 is preferably disposed on a PCB and on the inner surface 102 of the cover plate 100. The capacitance sensing circuit 400 can also be integrated into a chip which is disposed on the inner surface 102 of the cover plate 100. The capacitance sensing circuit 400 is electrically connected to the relay 200. The detection electrode 500 is preferably a metal sheet which is disposed on the inner surface 102 of the cover plate 100 and electrically connected to the capacitance sensing circuit 400.

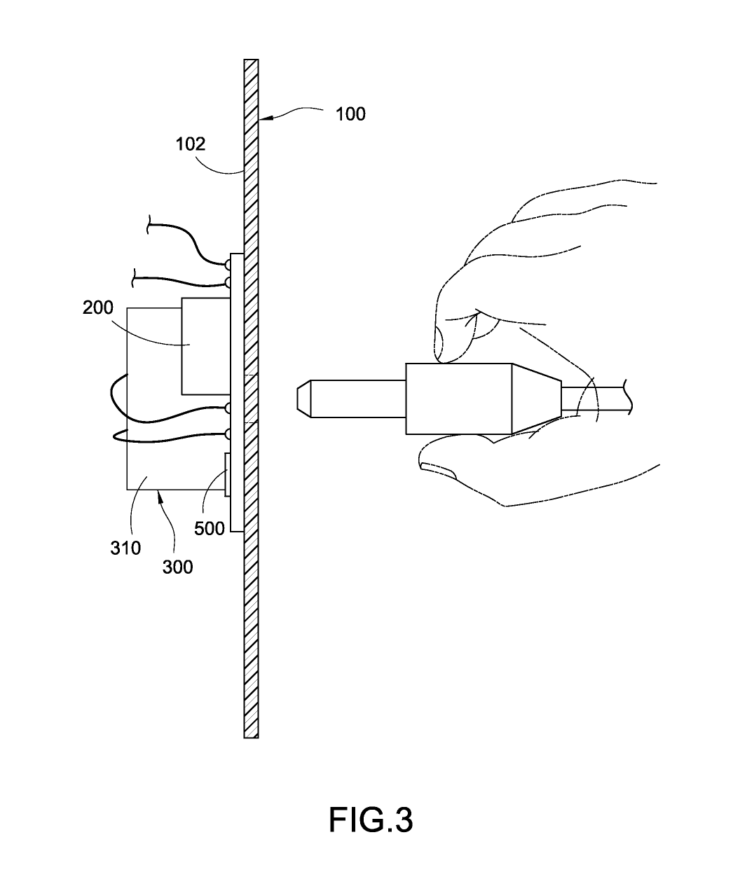

Please refer to FIG. 3. The above-mentioned detection electrode 500 has a capacitance value which will be affected to vary when an object (e.g., a user's hand) approaches. The closer the object approaches the detection electrode 500, the more significantly the capacitance value varies. When the capacitance value varies, the capacitance sensing circuit 400 sends a signal to open the relay 200 to stop the power supply from the mains supply for the socket base 300. When the user's hand leaves from the detection electrode 500, the capacitance sensing circuit 400 send a signal to the relay 200 which then restores the power supply from the mains supply for the socket base 300.

The method of sensing capacitance values using the detection electrode 500 and the capacitance sensing circuit 400 is given as follows. For example, the capacitance sensing circuit 400 may be an oscillation circuit, which is electrically connected to the detection electrode 500 to sense the variation of the capacitance value of the detection electrode 500. There is a specific amount of capacitance between the detection electrode 500 and the grounding of the capacitance sensing circuit 400. When the user's hand approaches the detection electrode 500, it will be affected by the voltage of the detection electrode 500 to be polarized and thus the charges of the detection electrode 500 increase. The closer the user's hand approaches the detection electrode 500, the more the charges of the detection electrode 500 increase. In the detection electrode 500, the amount of capacitance carried is proportional to the charges. Accordingly, the amount of capacitance of the detection electrode 500 increases. The increased capacitance of the detection electrode 500 reduces the oscillation of the capacitance sensing circuit 400. When the relay 200 detects the reduced oscillation of the capacitance sensing circuit 400 below a predetermined value, it immediately stops the power supply from the mains supply for the socket base 300. For example, the predetermined value can be set to an oscillation value corresponding to a distance of 10 cm between the approaching object and the detection electrode 500. Therefore, when the user approaches the detection electrode 500 within a distance of 10 cm, the oscillation value of the capacitance sensing circuit 400 is reduced below the predetermined value and the relay 200 immediately stops the power supply from the mains supply for the socket base 300 such that the electromagnetic wave intensity generated by the socket capable of detecting an approaching object of the present invention can be reduced. In this way, the Specific Absorption Rate (SAR) testing specification can be met by means of the socket capable of detecting an approaching object of the present invention.

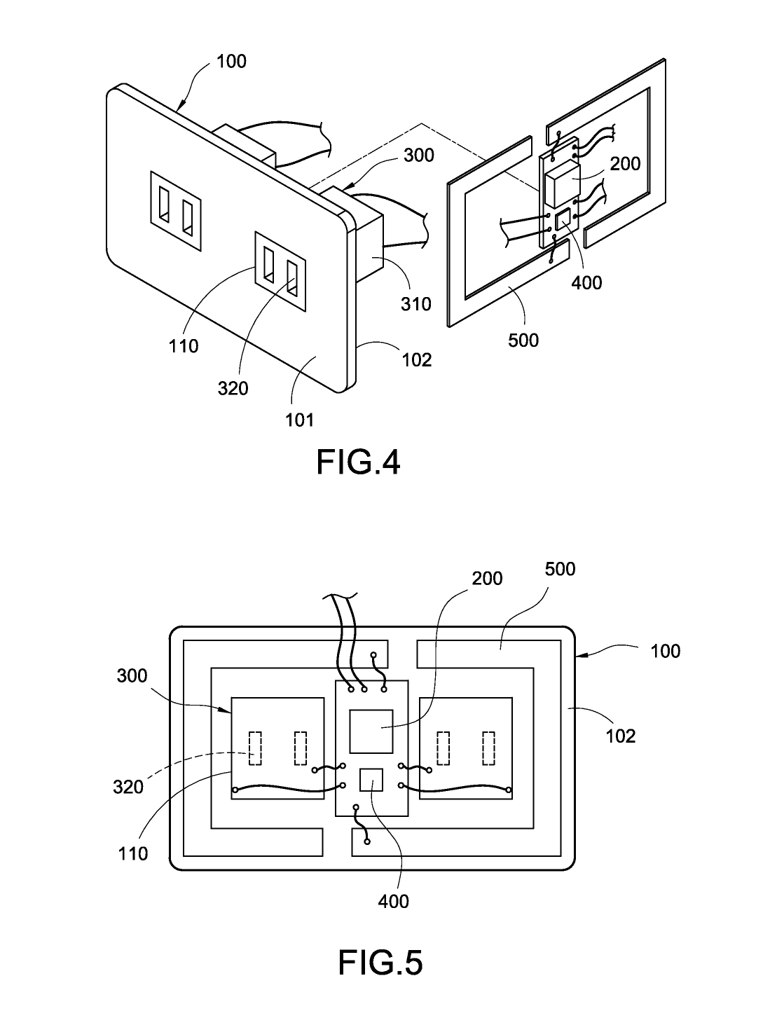

Please refer to FIGS. 4 and 5. The second embodiment of the present invention provides a socket capable of detecting an approaching object, which is used to be electrically connected to a mains supply. In the current embodiment, the socket capable of detecting an approaching object comprises a cover plate 100, a relay 200, two socket bases 300, a capacitance sensing circuit 400, and two detection electrodes 500.

The cover plate 100 is a cover body having a plate shape. Two opposite sides of the cover plate 100 are an outer surface 101 and an inner surface 102. The cover plate 100 has two through-holes 110. The relay 200, disposed on the inner surface 102, is electrically connected to the mains supply. Each socket base 300 is individually electrically connected to the relay 200. Each socket base 300 preferably comprises a rectangular insulator 310 which is disposed firmly in the corresponding through-hole 110 of the cover plate 100. The insulator 310 is provided with two insertion holes 320. Each of the two insertion holes 320 has a strip shape opening. The two openings of the two insertion holes 320 are arranged in parallel and are exposed from the through-hole 110 to the outer surface 101 of the cover plate 100. Each of the two insertion holes 320 is provided with an electrode and is electrically connected to the mains supply via the electrode. The capacitance sensing circuit 400 is preferably disposed on a PCB and on the inner surface 102 of the cover plate 100. The capacitance sensing circuit 400 can also be integrated into a chip which is disposed on the inner surface 102 of the cover plate 100. The capacitance sensing circuit 400 is electrically connected to the relay 200. Each of the detection electrodes 500 is preferably a metal sheet which is disposed on the inner surface 102 of the cover plate 100 and electrically connected to the capacitance sensing circuit 400. In the current embodiment, each of the detection electrodes 500 is a metal sheet having a strip shape and extends to surround the corresponding socket base 300. Thus, the accuracy of detecting an approaching object can be increased. The method of sensing capacitance values of the current embodiment is the same as that of the first embodiment and is not repeated here.

The socket capable of detecting an approaching object of the present invention detects an approaching object by means of the capacitance sensing circuit 500 and the detection electrode 400. Also, the relay 200 is used to control the power supply for the socket base 300 by means of the capacitance sensing circuit 400. Thus, an electric shock to the user is prevented.

The embodiments described above are only preferred ones of the present invention and not to limit the claimed scope of the present invention. Therefore, all the equivalent modifications and variations applying the spirit of the present invention should be embraced by the claimed scope of the present invention.

What is claimed is:

1. A socket capable of detecting an approaching object, the socket used to be electrically connected to a mains supply and comprising:
a relay electrically connected to the mains supply;
a socket base electrically connected to the relay and provided with two insertion holes having strip shapes and arranged in parallel;
a capacitance sensing circuit electrically connected to the relay; and
a detection electrode electrically connected to the capacitance sensing circuit.

2. The socket capable of detecting the approaching object according to claim 1, further comprising a cover plate having a through-hole in which the socket base is disposed, wherein the two insertion holes are located in the through-hole.

3. The socket capable of detecting the approaching object according to claim 1, wherein the detection electrode extends to surround the socket base.

4. The socket capable of detecting the approaching object according to claim 1, wherein there are a plurality of socket bases.

5. The socket capable of detecting the approaching object according to claim 4, further comprising a cover plate having a plurality of through-holes, wherein each of the socket bases is disposed in the corresponding through-hole, wherein the two insertion holes of the each of the socket bases are located in the corresponding through-hole.

6. The socket capable of detecting the approaching object according to claim 5, wherein there are a plurality of detection electrodes, each of the detection electrodes individually electrically connected to the capacitance sensing circuit.

7. The socket capable of detecting the approaching object according to claim 6, wherein each of the detection electrodes extends to surround the corresponding socket base.
